(19) United States
(12) Patent Application Publication
(10) Pub. No.: US 2022/0164237 A1
(43) Pub. Date: May 26, 2022

(54) CONFIGURATION OF A PACKET PROCESSING PIPELINE

(71) Applicant: Intel Corporation, Santa Clara, CA (US)

(72) Inventors: Steven R. KING, Portland, OR (US); Matthew VICK, Hillsboro, OR (US); Keren GUY, Sunnyvale, CA (US)

(21) Appl. No.: 17/667,422

(22) Filed: Feb. 8, 2022

(51) Int. Cl. G06F 9/50; G06F 9/445; G06F 8/71

(52) U.S. Cl. CPC G06F 9/5044; G06F 8/71; G06F 9/44505

(57) ABSTRACT

Examples described herein relate to a packet processing device comprising a programmable packet processing pipeline that is logically partitioned into multiple domains including privileged and unprivileged domains. The multiple domains can span one or more stages of the programmable packet processing pipeline, wherein at least one stage is to perform match action operations.

### BACKGROUND

In networking technology, some packet processing devices, such as network interface controllers and switches, include programmable packet processing pipelines. Programming a packet processing pipeline is transitioning from configuration by device drivers to configuration by compiled software flows. Packet processing pipelines can be programmed using OpenFlow, Programming Protocol-independent Packet Processor (P4) language, or other semantics. The P4 language for network devices specifies how data plane devices process packets. However, as packet processing pipelines grows in size and complexity, programming these pipelines becomes challenging.

In some cases, a packet processing pipeline is programmed in a monolithic manner by a team of developers that manage the pipeline. For example, a packet processing pipeline may execute different packet processing programs concurrently. For example, a program may encapsulate and decapsulate packets to implement a network tunnel. Another program may perform network address translation to implement load balancing across service endpoints.

### BRIEF DESCRIPTION OF THE DRAWINGS

FIG. 1 depicts an example system.

FIG. 2 depicts an example of operations.

FIG. 3 depicts an example system.

FIG. 4 depicts an example of operations.

FIG. 5 depicts an example process.

FIG. 6A depicts an example packet processing device.

FIG. 6B depicts an example switch.

FIG. 7 depicts an example computing system.

FIG. 8 depicts an example system.

### DETAILED DESCRIPTION

To reduce malfunction of the packet processing pipeline when packet processing programs are executed, a program can be stopped, updated, and restarted without disrupting other programs. To increase utilization of the pipeline, programs may be scheduled for execution. For example, a control plane may load a storage offload program to accelerate nighttime backups and disable the program when backup completes and cause execution of a different program, while attempting to avoid disruption of execution of other pipeline programs.

However, software developed to execute on a portion the packet processing pipeline can conflict with other software for a same or downstream portion of the packet processing pipeline. In some cases, performing bug fixes to remove errors from software can be challenging as removing errors from other software may also need to be performed.

To attempt to provide independent operation of software, software domains can be created and enforced within the programmable network pipeline and pipeline programs can execute independently within the domains. Programs in a domain may be loaded and unloaded at runtime without disrupting programs executing in other domains. Modular programming of packet processing pipelines can be utilized to configure multiple independent data planes in one or more packet processing pipelines of a network interface device. Components or circuitry of the programmable network pipeline can be modularized so that a component can be programmed separately and independently from another component and programming of the component is not permitted to impact operation of software executed on another component.

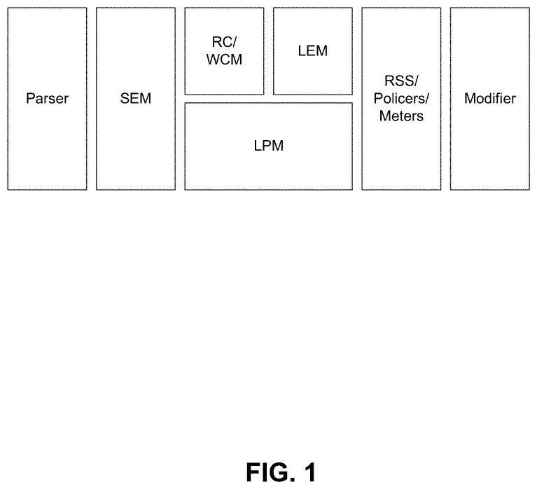

FIG. 1 depicts an example of a packet processing pipeline. For example, a packet processing pipeline can include multiple packet processing circuitries, wherein a packet processing circuitry is coupled to one or more other packet processing circuitries and a memory device. A packet processing circuitry can access a packet header and/or packet payload from memory or another packet processing circuitry and store the processed packet header and/or packet payload into memory or provide the processed packet header and/or packet payload to another packet processing circuitry.

A packet processing circuitry can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping).

For example, using a configuration, some packet processing circuitry can be identified as unshareable or shareable. Unshareable packet processing circuitry can execute a single software (threads) at a time. For example, a packet parser (parser) can be designated as unshareable. Sharable packet processing circuitry can execute two or more software at a time. For example, one or more of the following packet processing circuitry can be designated as shareable: exact match-action blocks (SEM), longest prefix match blocks (LEM), wildcard match blocks (WCM), range checker blocks (RC), packet modifier blocks (MOD) and so on. In a block, specific fine grained resources may be assigned to particular domains such that multiple domains may co-reside in the same block and software packages may utilize domains without disrupting operation of another software package.

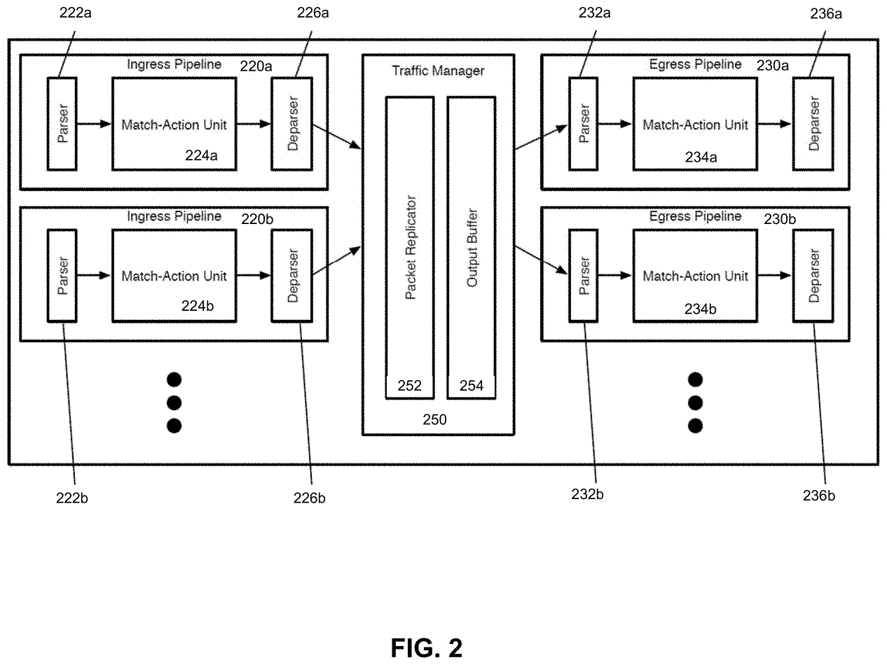

FIG. 2 depicts an example packet processing pipeline. One or more of the devices of this example packet processing pipeline can be utilized as shared or unshared and protections performed to stop execution of software in violation of configuration rules, as described herein. For example, FIG. 2 illustrates several ingress pipelines 220, a traffic management unit (referred to as a traffic manager) 250, and several egress pipelines 230. Though shown as separate structures, in some examples the ingress pipelines 220 and the egress pipelines 230 can use the same circuitry resources. In some examples, the pipeline circuitry is configured to process ingress and/or egress pipeline packets synchronously, as well as non-packet data. That is, a particular stage of the pipeline may process any combination of an ingress packet, an egress packet, and non-packet data in the same clock cycle. However, in other examples, the ingress and egress pipelines are separate circuitry. In some of these other examples, the ingress pipelines also process the non-packet data.

In some examples, in response to receiving a packet, the packet is directed to one of the ingress pipelines 220 where an ingress pipeline which may correspond to one or more ports of a hardware forwarding element. After passing through the selected ingress pipeline 220, the packet is sent to the traffic manager 250, where the packet is enqueued and placed in the output buffer 254. In some examples, the ingress pipeline 220 that processes the packet specifies into which queue the packet is to be placed by the traffic manager 250 (e.g., based on the destination of the packet or a flow identifier of the packet). The traffic manager 250 then dispatches the packet to the appropriate egress pipeline 230 where an egress pipeline may correspond to one or more ports of the forwarding element. In some examples, there is no necessary correlation between which of the ingress pipelines 220 processes a packet and to which of the egress pipelines 230 the traffic manager 250 dispatches the packet. That is, a packet might be initially processed by ingress pipeline 220b after receipt through a first port, and then subsequently by egress pipeline 230a to be sent out a second port, etc.

A least one ingress pipeline 220 includes a parser 222, plural match-action units (MAUs) 224, and a deparser 226. Similarly, egress pipeline 230 can include a parser 232, plural MAUs 234, and a deparser 236. The parser 222 or 232, in some examples, receives a packet as a formatted collection of bits in a particular order, and parses the packet into its constituent header fields. In some examples, the parser starts from the beginning of the packet and assigns header fields to fields (e.g., data containers) for processing. In some examples, the parser 222 or 232 separates out the packet headers (up to a designated point) from the payload of the packet, and sends the payload (or the entire packet, including the headers and payload) directly to the deparser without passing through the MAU processing.

MAUs 224 or 234 can perform processing on the packet data. In some examples, MAUs includes a sequence of stages, with a stage including one or more match tables and an action engine. A match table can include a set of match entries against which the packet header fields are matched (e.g., using hash tables), with the match entries referencing action entries. When the packet matches a particular match entry, that particular match entry references a particular action entry which specifies a set of actions to perform on the packet (e.g., sending the packet to a particular port, modifying one or more packet header field values, dropping the packet, mirroring the packet to a mirror buffer, etc.). The action engine of the stage can perform the actions on the packet, which is then sent to the next stage of the MAU. For example, MAU(s) can be used to determine whether to migrate data to another memory device and select another memory device, as described herein.

The deparser 226 or 236 can reconstruct the packet using a packet header vector (PHV) as modified by the MAU 224 or 234 and the payload received directly from the parser 222 or 232. The deparser can construct a packet that can be sent out over the physical network, or to the traffic manager 250. In some examples, the deparser can construct this packet based on data received along with the PHV that specifies the protocols to include in the packet header, as well as its own stored list of data container locations for possible protocol's header fields.

Traffic manager 250 can include a packet replicator 252 and output buffer 254. In some examples, the traffic manager 250 may include other components, such as a feedback generator for sending signals regarding output port failures, a series of queues and schedulers for these queues, queue state analysis components, as well as additional components. The packet replicator 252 of some examples performs replication for broadcast/multicast packets, generating multiple packets to be added to the output buffer (e.g., to be distributed to different egress pipelines).

The output buffer 254 can be part of a queuing and buffering system of the traffic manager in some examples. The traffic manager 250 can provide a shared buffer that accommodates any queuing delays in the egress pipelines. In some examples, this shared output buffer 254 can store packet data, while references (e.g., pointers) to that packet data are kept in different queues for egress pipeline 230. The egress pipelines can request their respective data from the common data buffer using a queuing policy that is control-plane configurable. When a packet data reference reaches the head of its queue and is scheduled for dequeuing, the corresponding packet data can be read out of the output buffer 254 and into the corresponding egress pipeline 230. In some examples, packet data may be referenced by multiple pipelines (e.g., for a multicast packet). In this case, the packet data is not removed from this output buffer 254 until references to the packet data have cleared their respective queues.

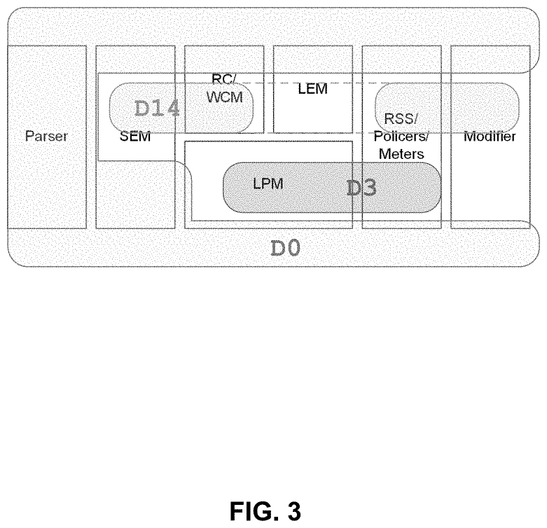

FIG. 3 depicts an example of programmable domains in a packet processing pipeline. A packet processing pipeline can be partitioned into multiple domains. This example depicts three domains but more or fewer domains can be used such as two or more domains. Three domains are shown, labeled Domain 0 (D0), Domain 3 (D3), and Domain 14 (D14).

In addition, or alternative to designation of packet processing circuitry as unshareable or shareable, partitioning of packet processing circuitry can be utilized. For example, a compiler, assembler, or runtime library can define boundary points that include one or more packet processing circuitry. One or more software mechanisms (e.g., compiler, lint check, runtime check, assembler, or runtime library) can define boundaries of software execution.

For example, boundary points can be designated to limit or permit particular software to operate on one or more packet processing circuitry. A programming manual can define boundaries of software execution on one or more packet processing circuitry to developers.

Shared domain boundaries can be defined by controls that indicate shared and unshared hardware. For example, a domain can refer to one or more packet processing circuitry. A domain 0 can refer to shared hardware whereas a domain 1−N can refer to unshared hardware. A privileged domain can include certain unshareable hardware whereas an unprivileged domain can include shareable or unshareable hardware. In some examples, a privileged domain is referred to as domain 0. A defined hardware boundary can be provided between privileged domain 0 and unprivileged domains.

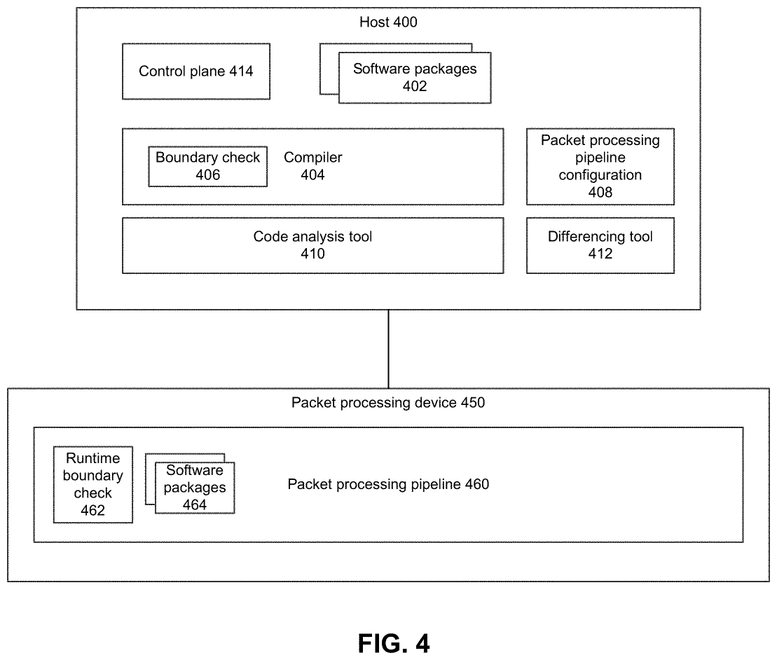

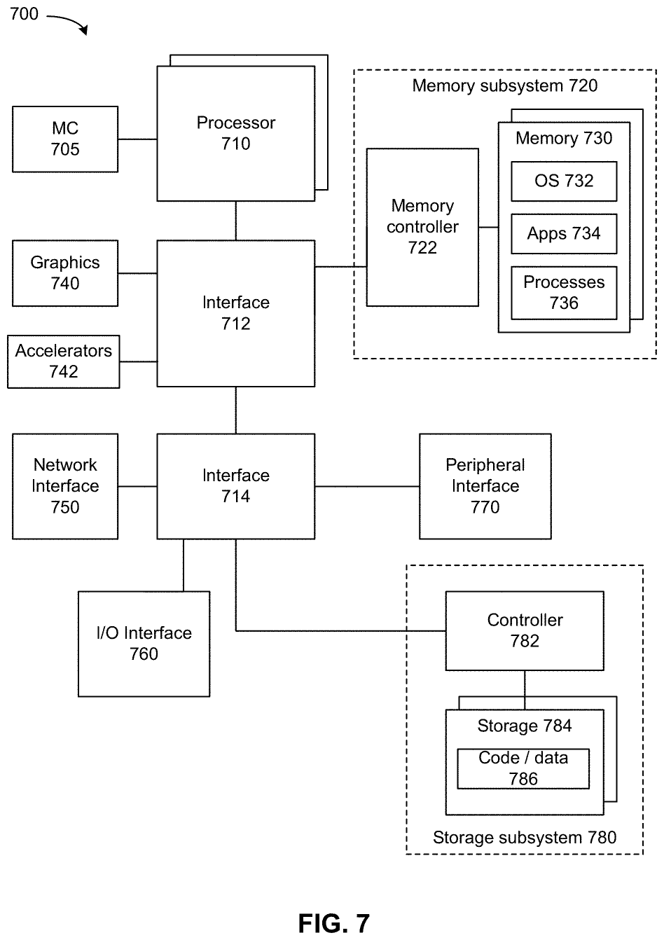

FIG. 4 depicts an example system. Host 400 can be implemented as a computing platform at least with one or more processors, one or more memory devices, interconnect circuitry, and one or more device interfaces. Various examples of a computing platform are described with respect to the system of FIG. 7. Various elements shown in FIG. 4 can be implemented as processor-executed software, software stored in memory, data stored in memory, and/or circuitry. One or more software packages 402 can be stored in memory of host 400. One or more software packages 402 can be written in P4, Broadcom Network Programming Language (NPL), or others. For example, execution of a software package may initiate encapsulation and decapsulation packets to implement a network tunnel. Execution of another software package may perform network address translation to implement load balancing across service endpoints.

For example, one or more software packages 402 can include semantics that specify particular hardware to execute a machine executable format of one or more software packages 402. For example, a software package can claim exclusive or non-exclusive ownership of a hardware resource. An example of ownership or reservation claim is as follows:

// Using the SEM requires allocation of:
// * profile match keys to pick a SEM profile
// * profiles themselves
//
@company_config(″owner″, ″SEM_PROFILE″, 256, 511) // 256 SEM profile keys
@company_config(″owner″, ″SEM_PROFILE_CFG″, 64, 65) // 2 SEM profiles, IPv4 and
IPv6
@company_config(″owner″, ″LEM_PROFILE_CFG″, 64, 65) // 2 LEM profiles, IPv4 and
IPv6
@company_config(″owner″, ″WLPG_PROFILE″, 256) // 256 WLPG profiles for driving
the LEM

Compiler 404 may include multiple executable software including one or more of: a compiler to assembly language, assembler compiler to translate assembly language program to machine code, linking software, disassembler, and so forth.

In some examples, a processor can execute compiler 404 to compile one or more software packages 402 into assembly language or machine executable instructions. In connection with compiling one or more software packages 402 into assembly language or machine executable instructions, compiler 404 can determine if a software package executes within a permitted boundary and guard from multiple packages requesting use of resource in conflict with an applicable sharing rule. For example, packet processing pipeline configuration 408 can request utilization of one or more packet processing circuitries.

For example, packet processing pipeline configuration 408 can be implemented as at least some of the data in the table as shown below.

| | | Software package |
|---|---|---|
| Domain | Packet processing pipeline | utilizing domain |
| number | resource(s) | (.pkg file) |
| D0 | Parser, SEM, LPM, RC/WCM, | 0x0000 |
| | LEM, RSS/Policers/Meters, modifier | |
| D3 | LPM, RSS/Policers/Meters | 0x0001 |

A domain can be associated with one or more pipeline circuitries. When control plane software (e.g., network services library) executing on host 400 or firmware executing on a packet processing device 450 installs a new domain, control plane software can add the resources for that domain to the list of tracked resources for installed domains in packet processing pipeline configuration 408. When uninstalling a domain, control plane software can remove the resources for that domain from packet processing pipeline configuration 408.

Compiler 404 can utilize boundary check 406 to access packet processing pipeline configuration 408 to perform a conflict check of an ownership violation or if a single software package (e.g., mini package) can utilize a hardware device to process a packet. Compiler 404 can check for ownership conflicts arising from a software package requesting utilization of a particular packet processing pipeline resource or circuitry and identify and reject a request or configuration to utilize of a particular packet processing pipeline resource. For example, compiler 404 can determine if a software package requests hardware usage in violation of a boundary between domain 0 and unprivileged domains. Compiler 404 can reject requests or configurations in a software package that violate an exclusivity parameter associated with a boundary or packet processing pipeline resource by reporting an error and halting compiling the software package. Compiler 404 can convert one or more software packages into a .pkg file based on passing conflict checks.

Some examples of compiler 404 can build a binary decision diagram (BDD) from a set of logical match conditions based on exclusivity or non-exclusivity of a packet processing resource. The compiler 404 can convert the BDD into a machine readable array that may be stored in a file or computer memory. In some examples, compiler 404 can cause a hardware matching unit in a packet processing pipeline 460 to perform exact or ternary match operations on fields of a packet to select the installed software package 464 that are to process the packet. To detect match conflicts, code analysis tool 410 or runtime boundary check 462 may perform a logical-AND operation of a BDD of a domain to the BDDs of installed domains. The BDD logical-AND operation provides an efficient indicator if a new package expects to process packets already allocated to an installed package. The check can reject a request to utilize a packet processing circuitry based on conflict with exclusivity of domain or packet processing circuitry.

When installing a new domain, control plane software can identify a version of a domain in configuration 408. Control plane 414 can detect version conflicts between a domain and domain 0 and reject configurations with version conflicts.

In some examples, differencing tool 412 can determine differences between two versions of the same domain in terms of register level configurations. For example, a domain may set a certain register value to 0, but a new version of the domain may set the same register value to 1. Software differencing tool 412 can collect these changes together into a patch file. A control plane may update an installed domain using the patch file, thereby avoiding the need to reconfigure unchanged registers. Control plane 414 can quash a configuration of an unprivileged domain configuration to reset registers by setting register values to a default state. When uninstalling a domain, control plane 414 can overwrite a configuration of an unprivileged domain and restore hardware configurations to a known state.

In some examples, control plane 414 can determine differences between domains in terms of register level configurations. An update to an installed domain using the result of the register level differences can identify differences in register configurations. Control plane software can detect register level differences between a domain and domain 0 and reject configurations that conflict with permitted register configurations. Control plane 414 can quash a configuration of an unprivileged domain configuration to reset registers by setting register values to a default state. When uninstalling a domain, control plane 414 can overwrite a configuration of an unprivileged domain and restore hardware configurations to a known state.

Code analysis tool 410 executed on host 400 can perform a check of sharing and exclusivity in a similar manner as that of compiler 404 and runtime boundary check 462 and perform version checking of a software package after it is compiled. For example, a software package can request use of a domain and specify its version number. Code analysis tool 410 can check a version of a domain against a version specified in a compiled software package. For example, a developer can specify a domain and a version number to utilize. Sharing properties of packet processing circuitry can be associated with a particular version number. If sharing properties of packet processing circuitry are updated, then an expected version number provided by a developer in a software package would not match a current version number associated with a domain and an error can be indicated by code analysis tool 410. This error gives an early conflict indication before attempting to install a package. The early error avoids the need to attempt to deploy the package and fail by runtime boundary check 462. The error can be indicated to a user and the software package not permitted to be provided to packet processing pipeline 460.

Code analysis tool 410 can inspect software packages from different developer teams to check if packages do not cause conflict. For example, if two packages attempt to process the same packet, a conflict can be detected. Code analysis tool 410 can check hardware resource capacity to make sure no overruns of hardware resources will occur.

Packet processing pipeline 460 can load compiled software packages 464 from host 400 such as a binary package format (.pkg). Packet processing pipeline 460 can perform a runtime boundary check 462 to determine exclusivity violations and version conflicts when the compiled software packages 464 are loaded into packet processing pipeline 460. In some examples, runtime boundary check 462 can run in firmware in packet processing device 450. Runtime boundary check 462 can attempt to avoid packet processing pipeline 460 crashing from such conflicts.

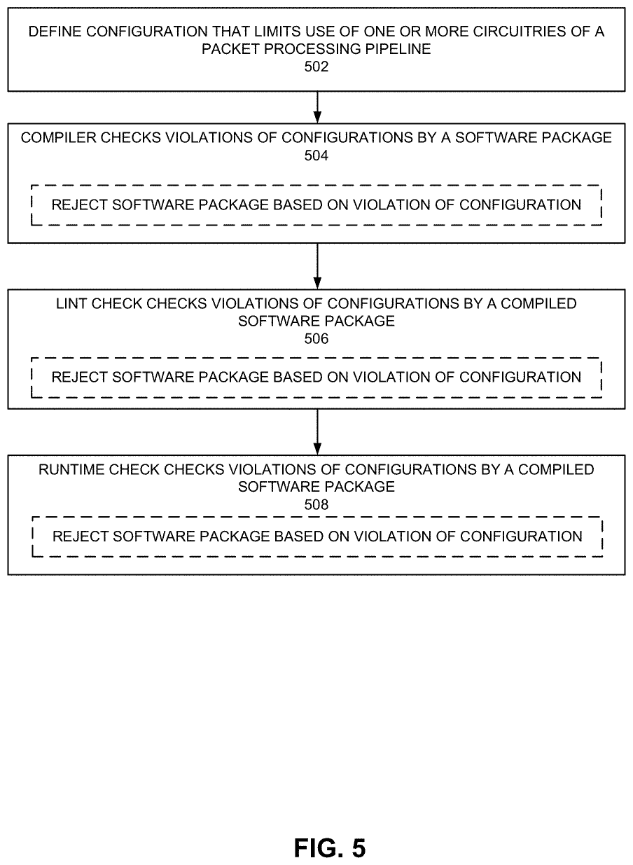

FIG. 5 depicts an example process. The process can be used to configure utilization of circuitry of a packet processing pipeline. At 502, utilization of circuitry of packet processing pipeline can be specified in a configuration file. Various examples of circuitry of a packet processing pipeline can be identified as able to be utilized by multiple software packages or merely a single software package. In some examples, circuitry of a packet processing pipeline that performs one or more software packages can merely permit a packet to be processed by a single software package.

At 504, a compiler can compile a software package and check if the configuration is valid for the packet processing pipeline hardware. For example, if a compiled software package attempts to configure circuitry of a packet processing pipeline in violation of capability of the hardware, the compiler can issue an alert that an error occurred during compiling the software package and halt compilation. The compiler can identify the nature of the error and report to the user.

At 506, for compiled software that passes a compiler check, a code analysis tool (e.g., lint checker) can perform additional checks and also perform a version check. A version check can include determining if a version of a configuration applicable to the circuitry of the packet processing pipeline violates a version of the configuration identified by the software package. For example, if a compiled software package attempts to configure circuitry of a packet processing pipeline in violation of the configuration or a version violation occurs, the lint check can issue an alert that an error that indicates whether the configuration was violated or a version check failed.

At 508, for compiled software that passes a compiler check and lint check and is loaded into a packet processing pipeline for execution, a run time check can be performed by the packet processing pipeline to perform a conflict check and version check. For example, if a compiled software package attempts to configure circuitry of a packet processing pipeline in violation of the configuration or a version violation occurs, the runtime check can prevent loading of the compiled software package and prevent disruption of already installed install packages.

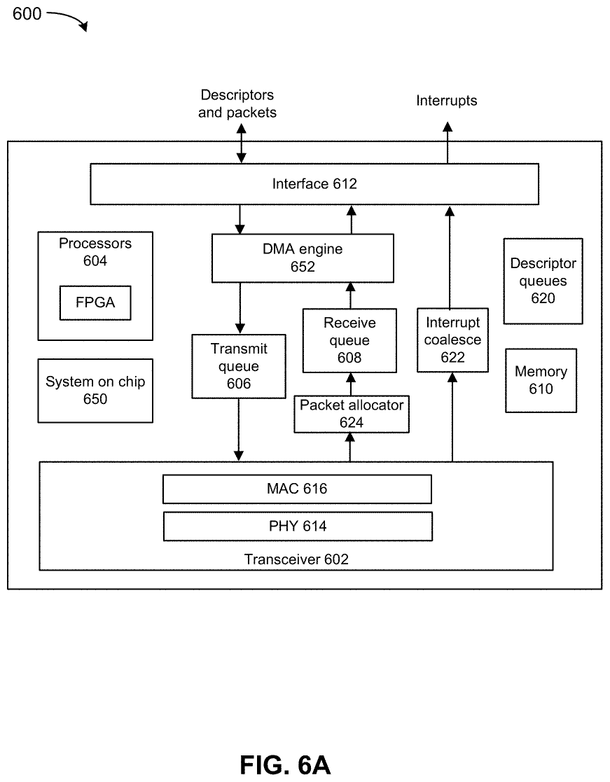

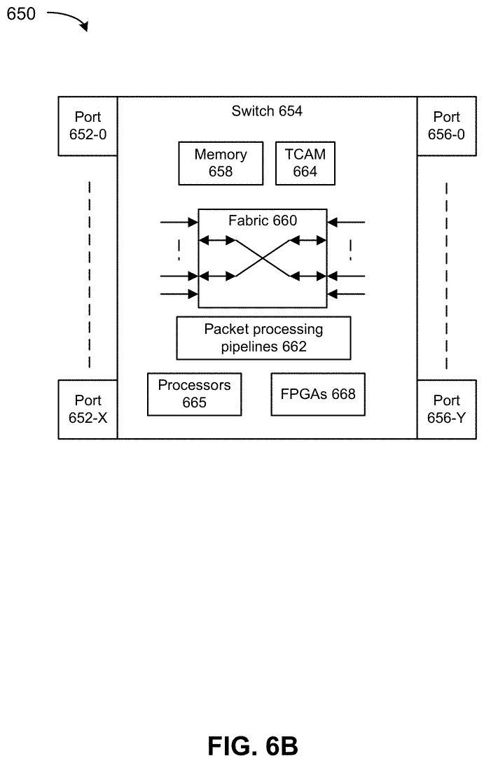

FIG. 6A depicts an example packet processing device. The network interface device can be configured for usage by one or more software packages and perform a check against violations of a hardware configuration or version, as described herein. Network interface 600 can include transceiver 602, processors 604, transmit queue 606, receive queue 608, memory 610, and bus interface 612, and DMA engine 652. Transceiver 602 can be capable of receiving and transmitting packets in conformance with the applicable protocols such as Ethernet as described in IEEE 802.3, although other protocols may be used. Transceiver 602 can receive and transmit packets from and to a network via a network medium (not depicted). Transceiver 602 can include PHY circuitry 614 and media access control (MAC) circuitry 616. PHY circuitry 614 can include encoding and decoding circuitry (not shown) to encode and decode data packets according to applicable physical layer specifications or standards. MAC circuitry 616 can be configured to assemble data to be transmitted into packets, that include destination and source addresses along with network control information and error detection hash values.

Processors 604 can be any a combination of a: processor, core, graphics processing unit (GPU), field programmable gate array (FPGA), application specific integrated circuit (ASIC), or other programmable hardware device that allow programming of network interface 600. For example, a “smart network interface” can provide packet processing capabilities in the network interface using processors 604. Configuration of operation of processors 604, including its data plane, can be programmed using Programming Protocol-independent Packet Processors (P4), C, Python, Broadcom Network Programming Language (NPL), or x86 compatible executable binaries or other executable binaries. Processors 604 and/or system on chip 650 can execute instructions to configure and utilize one or more circuitry as well as check against violation against use configurations, as described herein.

Packet allocator 624 can provide distribution of received packets for processing by multiple CPUs or cores using timeslot allocation described herein or RSS. When packet allocator 624 uses RSS, packet allocator 624 can calculate a hash or make another determination based on contents of a received packet to determine which CPU or core is to process a packet.

Interrupt coalesce 622 can perform interrupt moderation whereby network interface interrupt coalesce 622 waits for multiple packets to arrive, or for a time-out to expire, before generating an interrupt to host system to process received packet(s). Receive Segment Coalescing (RSC) can be performed by network interface 600 whereby portions of incoming packets are combined into segments of a packet. Network interface 600 provides this coalesced packet to an application.

Direct memory access (DMA) engine 652 can copy a packet header, packet payload, and/or descriptor directly from host memory to the network interface or vice versa, instead of copying the packet to an intermediate buffer at the host and then using another copy operation from the intermediate buffer to the destination buffer.

Memory 610 can be any type of volatile or non-volatile memory device and can store any queue or instructions used to program network interface 600. Transmit queue 606 can include data or references to data for transmission by network interface. Receive queue 608 can include data or references to data that was received by network interface from a network. Descriptor queues 620 can include descriptors that reference data or packets in transmit queue 606 or receive queue 608. Bus interface 612 can provide an interface with host device (not depicted). For example, bus interface 612 can be compatible with PCI, PCI Express, PCI-x, Serial ATA, and/or USB compatible interface (although other interconnection standards may be used).

FIG. 6B depicts an example switch. Various device and processor resources in the switch can be configured for usage by one or more software packages and perform a check against violations of a hardware configuration or version, as described herein. Switch 654 can route packets or frames of any format or in accordance with any specification from any port 652-0 to 652-X to any of ports 656-0 to 656-Y (or vice versa). Any of ports 652-0 to 652-X can be connected to a network of one or more interconnected devices. Similarly, any of ports 656-0 to 656-Y can be connected to a network of one or more interconnected devices.

In some examples, switch fabric 660 can provide routing of packets from one or more ingress ports for processing prior to egress from switch 654. Switch fabric 660 can be implemented as one or more multi-hop topologies, where example topologies include torus, butterflies, buffered multi-stage, etc., or shared memory switch fabric (SMSF), among other implementations. SMSF can be any switch fabric connected to ingress ports and all egress ports in the switch, where ingress subsystems write (store) packet segments into the fabric's memory, while the egress subsystems read (fetch) packet segments from the fabric's memory.

Memory 658 can be configured to store packets received at ports prior to egress from one or more ports. Packet processing pipelines 662 can determine which port to transfer packets or frames to using a table that maps packet characteristics with an associated output port. Packet processing pipelines 662 can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines 662 can implement access control list (ACL) or packet drops due to queue overflow.

Packet processing pipelines 662 can be configured by software packages described herein. Packet processing pipelines 662 can check for violations of configurations of hardware usages by a software package. Processors 665 and FPGAs 668 can be utilized for packet processing or modification.

FIG. 7 depicts a system. Components of system 700 (e.g., processor 710, network interface 750, and so forth) to configure processor resources for shared or exclusive use and check against violations of such configurations by software packages, as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a display that provides an output to a user. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

As described herein, processor 710 can execute a compiler and lint check that checks for violations of configurations of hardware usages.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, network interface 750 can refer to one or more of: a network interface controller (NIC), a remote direct memory access (RDMA)-enabled NIC, SmartNIC, router, switch, forwarding element, infrastructure processing unit (IPU), or data processing unit (DPU).

As described herein, network interface 750 can check if a compiled software, that is to be executed by network interface 750, for violations of configurations of hardware usages.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

In an example, system 700 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

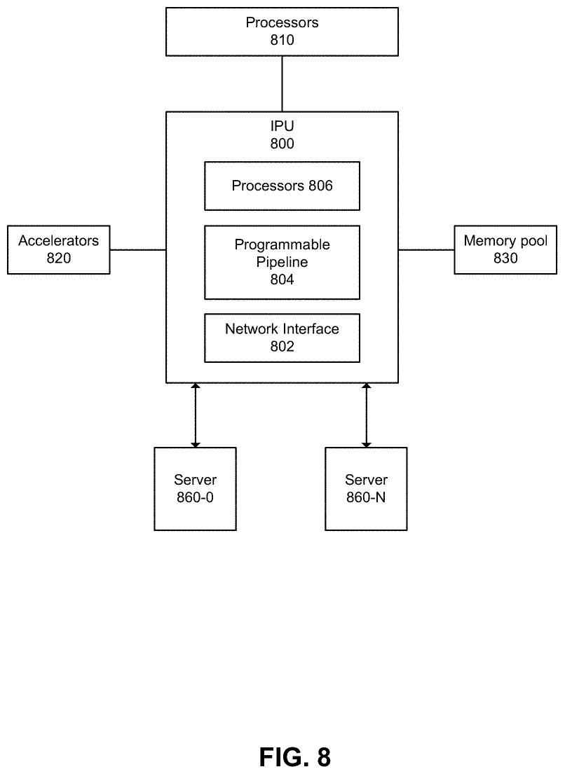

FIG. 8 depicts an example system. In this system, IPU 800 manages performance of one or more processes using one or more of processors 806, processors 810, accelerators 820, memory pool 830, or servers 840-0 to 840-N, where N is an integer of 1 or more. In some examples, processors 806 of IPU 800 can execute one or more processes, applications, VMs, containers, microservices, and so forth that request performance of workloads by one or more of: processors 810, accelerators 820, memory pool 830, and/or servers 840-0 to 840-N. IPU 800 can utilize network interface 802 or one or more device interfaces to communicate with processors 810, accelerators 820, memory pool 830, and/or servers 840-0 to 840-N. IPU 800 can utilize programmable pipeline 804 to process packets that are to be transmitted from network interface 802 or packets received from network interface 802. In some examples, configuration of programmable pipelines 804 can be partitioned into boundaries with exclusive and shared use of circuitry. IPU 800 can perform checking against violations by compiled software of exclusive boundaries and versions, described herein.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for another. For example, descriptions using the terms “connected” and/or “coupled” may indicate that two or more elements are in direct physical or electrical contact with another. The term “coupled,” however, may also mean that two or more elements are not in direct contact with another, but yet still co-operate or interact with another.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. A component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

Example 1 includes one or more examples, and includes a non-transitory computer-readable medium comprising instructions stored thereon, that if executed by one or more processors, cause the one or more processors to: control addition of a program for execution by a programmable packet processing pipeline while maintaining operation of programs currently executing on the programmable packet processing pipeline.

Example 2 includes one or more examples, wherein the control addition of a program for execution by a programmable packet processing pipeline while maintaining operation of programs currently executing on the programmable packet processing pipeline comprises: process a software package to be executed by a programmable packet processing pipeline of a packet processing device to determine whether the software package is to utilize hardware of the programmable packet processing pipeline in a manner consistent with a configuration limiting hardware utilization; compile the software package based on the software package not violating the configuration limiting hardware utilization; or reject the software package based on violation of the configuration limiting hardware utilization.

Example 3 includes one or more examples, wherein the configuration limiting hardware utilization is to specify whether one or more hardware of the programmable packet processing pipeline is sharable with one or more other software packages or exclusive to execution by a single software package.

Example 4 includes one or more examples, wherein the configuration limiting hardware utilization is to specify a version of the configuration limiting hardware utilization and comprising instructions stored thereon, that if executed by one or more processors, cause the one or more processors to: reject a configuration in the software package that refers to a version that violates the specified version.

Example 5 includes one or more examples, and includes instructions stored thereon, that if executed by one or more processors, cause the one or more processors to: cause the programmable packet processing pipeline to process the compiled software package to determine whether the compiled software package is to utilize hardware of the programmable packet processing pipeline in a manner consistent with the configuration limiting hardware utilization and cause the programmable packet processing pipeline to indicate rejection of the compiled software package based on violation of the configuration limiting hardware utilization.

Example 6 includes one or more examples, wherein the programmable packet processing pipeline comprises one or more of: a parser, exact match-action circuitry, wildcard match-action (WCM) circuitry, longest prefix match block (LPM) circuitry, a hash circuitry, a packet modifier, or traffic manager.

Example 7 includes one or more examples, wherein the programmable packet processing device comprises one or more of: a network interface controller (NIC), a remote direct memory access (RDMA)-enabled NIC, SmartNIC, router, switch, forwarding element, infrastructure processing unit (IPU), or data processing unit (DPU).

Example 8 includes one or more examples, and includes an apparatus comprising: a packet processing device comprising a programmable packet processing pipeline that is logically partitioned into multiple domains including privileged and unprivileged domains.

Example 9 includes one or more examples, wherein: the multiple domains span one or more stages of the programmable packet processing pipeline, wherein at least one stage is to perform match action operations.

Example 10 includes one or more examples, wherein: the privileged domain comprises an unshared domain and the unprivileged domain comprises a shared domain.

Example 11 includes one or more examples, wherein the programmable packet processing pipeline is to execute a compiled software package, wherein the execution of the compiled software package is to utilize hardware of the programmable packet processing pipeline in a manner consistent with a configuration limiting hardware utilization and wherein the configuration limiting hardware utilization is to specify one or more of: whether a domain of hardware is privileged or unprivileged or a version of the configuration limiting hardware utilization.

Example 12 includes one or more examples, wherein the packet processing device comprises circuitry to: process the compiled software package to determine whether the compiled software package is to utilize hardware of the programmable packet processing pipeline in a manner consistent with the configuration limiting hardware utilization and indicate rejection of the compiled software package based on violation of the configuration limiting hardware utilization.

Example 13 includes one or more examples, and includes a host computing system, wherein the host computing system comprises at least one processor to execute a compiler that is to: process a software package to determine whether the software package is to utilize hardware of the programmable packet processing pipeline in a manner consistent with the configuration limiting hardware utilization; reject the software package based on violation of the configuration limiting hardware utilization; and compile the software package based on the software package not violating the configuration limiting hardware utilization and the packet processing device is to access the compiled software package from the host computing system.

Example 14 includes one or more examples, wherein the programmable packet processing pipeline comprises one or more of: a parser, exact match-action circuitry, wildcard match-action (WCM) circuitry, longest prefix match block (LPM) circuitry, a hash circuitry, a packet modifier, or traffic manager.

Example 15 includes one or more examples, and includes a method that includes managing addition of a program for execution by a programmable packet processing pipeline while maintaining operation of programs currently executing on the programmable packet processing pipeline.

Example 16 includes one or more examples, and includes processing a software package to determine whether the software package is to utilize hardware of a programmable packet processing pipeline in a manner consistent with a configuration limiting hardware utilization; rejecting the software package based on violation of the configuration limiting hardware utilization; and compiling the software package based on the software package not violating the configuration limiting hardware utilization.

Example 17 includes one or more examples, and includes processing the compiled software package to determine whether the compiled software package is to utilize hardware of the programmable packet processing pipeline in a manner consistent with the configuration limiting hardware utilization and indicating rejection of the compiled software package based on violation of the configuration limiting hardware utilization.

Example 18 includes one or more examples, wherein the configuration limiting hardware utilization specifies whether one or more hardware of the programmable packet processing pipeline is sharable with one or more other software packages or exclusive to execution by a single software package.

Example 19 includes one or more examples, wherein the configuration limiting hardware utilization specifies a version of the configuration limiting hardware utilization and comprising: rejecting the software package based on violation of the version of the configuration limiting hardware utilization.

Example 20 includes one or more examples, wherein the programmable packet processing pipeline comprises one or more of: a parser, exact match-action circuitry, wildcard match-action (WCM) circuitry, longest prefix match block (LPM) circuitry, a hash circuitry, a packet modifier, or traffic manager.

What is claimed is:

1. A non-transitory computer-readable medium comprising instructions stored thereon, that if executed by one or more processors, cause the one or more processors to:
control addition of a program for execution by a programmable packet processing pipeline while maintaining operation of programs currently executing on the programmable packet processing pipeline.

2. The non-transitory computer-readable medium of claim 1, wherein the control addition of a program for execution by a programmable packet processing pipeline while maintaining operation of programs currently executing on the programmable packet processing pipeline comprises:
process a software package to be executed by a programmable packet processing pipeline of a packet processing device to determine whether the software package is to utilize hardware of the programmable packet processing pipeline in a manner consistent with a configuration limiting hardware utilization;
compile the software package based on the software package not violating the configuration limiting hardware utilization; or
reject the software package based on violation of the configuration limiting hardware utilization.

3. The non-transitory computer-readable medium of claim 2, wherein the configuration limiting hardware utilization is to specify whether one or more hardware of the programmable packet processing pipeline is sharable with one or more other software packages or exclusive to execution by a single software package.

4. The non-transitory computer-readable medium of claim 2, wherein the configuration limiting hardware utilization is to specify a version of the configuration limiting hardware utilization and comprising instructions stored thereon, that if executed by one or more processors, cause the one or more processors to:
reject a configuration in the software package that refers to a version that violates the specified version.

5. The non-transitory computer-readable medium of claim 2, comprising instructions stored thereon, that if executed by one or more processors, cause the one or more processors to:
cause the programmable packet processing pipeline to process the compiled software package to determine whether the compiled software package is to utilize hardware of the programmable packet processing pipeline in a manner consistent with the configuration limiting hardware utilization and
cause the programmable packet processing pipeline to indicate rejection of the compiled software package based on violation of the configuration limiting hardware utilization.

6. The non-transitory computer-readable medium of claim 1, wherein the programmable packet processing pipeline comprises one or more of: a parser, exact match-action circuitry, wildcard match-action (WCM) circuitry, longest prefix match block (LPM) circuitry, a hash circuitry, a packet modifier, or traffic manager.

7. The non-transitory computer-readable medium of claim 1, wherein the programmable packet processing device comprises one or more of: a network interface controller (NIC), a remote direct memory access (RDMA)-enabled NIC, SmartNIC, router, switch, forwarding element, infrastructure processing unit (IPU), or data processing unit (DPU).

8. An apparatus comprising:
a packet processing device comprising a programmable packet processing pipeline that is logically partitioned into multiple domains including privileged and unprivileged domains.

9. The apparatus of claim 8, wherein:
the multiple domains span one or more stages of the programmable packet processing pipeline, wherein at least one stage is to perform match action operations.

10. The apparatus of claim 8, wherein:
the privileged domain comprises an unshared domain and the unprivileged domain comprises a shared domain.

11. The apparatus of claim 8, wherein the programmable packet processing pipeline is to execute a compiled software package, wherein the execution of the compiled software package is to utilize hardware of the programmable packet processing pipeline in a manner consistent with a configuration limiting hardware utilization and wherein the configuration limiting hardware utilization is to specify one or more of: whether a domain of hardware is privileged or unprivileged or a version of the configuration limiting hardware utilization.

12. The apparatus of claim 11, wherein the packet processing device comprises circuitry to:
process the compiled software package to determine whether the compiled software package is to utilize hardware of the programmable packet processing pipeline in a manner consistent with the configuration limiting hardware utilization and indicate rejection of the compiled software package based on violation of the configuration limiting hardware utilization.

13. The apparatus of claim 11, comprising:
a host computing system, wherein the host computing system comprises at least one processor to execute a compiler that is to:
process a software package to determine whether the software package is to utilize hardware of the programmable packet processing pipeline in a manner consistent with the configuration limiting hardware utilization;
reject the software package based on violation of the configuration limiting hardware utilization; and
compile the software package based on the software package not violating the configuration limiting hardware utilization and
the packet processing device is to access the compiled software package from the host computing system.

14. The apparatus of claim 8, wherein the programmable packet processing pipeline comprises one or more of: a parser, exact match-action circuitry, wildcard match-action (WCM) circuitry, longest prefix match block (LPM) circuitry, a hash circuitry, a packet modifier, or traffic manager.

15. A method comprising:
managing addition of a program for execution by a programmable packet processing pipeline while maintaining operation of programs currently executing on the programmable packet processing pipeline.

16. The method of claim 15, comprising:
processing a software package to determine whether the software package is to utilize hardware of a programmable packet processing pipeline in a manner consistent with a configuration limiting hardware utilization;
rejecting the software package based on violation of the configuration limiting hardware utilization; and
compiling the software package based on the software package not violating the configuration limiting hardware utilization.

17. The method of claim 16, comprising:
processing the compiled software package to determine whether the compiled software package is to utilize hardware of the programmable packet processing pipeline in a manner consistent with the configuration limiting hardware utilization and
indicating rejection of the compiled software package based on violation of the configuration limiting hardware utilization.

18. The method of claim 16, wherein:
the configuration limiting hardware utilization specifies whether one or more hardware of the programmable packet processing pipeline is sharable with one or more other software packages or exclusive to execution by a single software package.

19. The method of claim 16, wherein the configuration limiting hardware utilization specifies a version of the configuration limiting hardware utilization and comprising:
rejecting the software package based on violation of the version of the configuration limiting hardware utilization.

20. The method of claim 16, wherein the programmable packet processing pipeline comprises one or more of: a parser, exact match-action circuitry, wildcard match-action (WCM) circuitry, longest prefix match block (LPM) circuitry, a hash circuitry, a packet modifier, or traffic manager.
